(19) United States
(12) Patent Application Publication
(10) Pub. No.: US 2012/0062752 A1
(43) Pub. Date: Mar. 15, 2012

(54) POWER CONVERSION CIRCUIT AND INTERNET PROTOCOL CAMERA EMPLOYING THE SAME

(75) Inventor: MING-CHIH HSIEH, Tu-Cheng (TW)

(73) Assignee: HON HAI PRECISION INDUSTRY CO., LTD., Tu-Cheng (TW)

(21) Appl. No.: 12/915,032

(22) Filed: Oct. 29, 2010

(30) Foreign Application Priority Data
Sep. 10, 2010 (TW) 99130771

(51) Int. Cl. H04N 5/225; G05F 1/10

(52) U.S. Cl. 348/207.1; 323/234; 348/E05.024

(57) ABSTRACT

A power conversion circuit for an internet protocol camera includes a voltage conversion circuit and a divider circuit electrically connected to the voltage conversion circuit. The voltage conversion circuit includes a linear voltage regulator for providing an operating voltage. The linear voltage regulator includes an input port, an output port and a feedback port. The divider circuit includes a first divider resistance and a second divider resistance. The output pot, the first divider resistance and the second divider resistance are electrically connected in series, the feedback port is electrically connected between the first divider resistance and the second divider resistance to obtain a feedback voltage. The input port is electrically a system power, and the output port outputs and provides an output voltage adjusted by the feedback voltage.

### BACKGROUND

1. Technical Field

The disclosure generally relates to power conversion circuits, and more particularly relates to a power conversion circuit used in an internet protocol (IP) camera.

2. Description of the Related Art

IP cameras are commonly employed for surveillance, and send and receive data via a computer network and the internet. An IP camera typically includes a system on chip (SOC)/central processing unit (CPU), image processing chips, audio chips, and system power, which are electrically located on a main board of the IP camera. Moreover, image sensors, such as complementary metal oxide semiconductor (CMOS) sensors or charge coupled device (CCD) sensors, and a sub-power source are usually electrically located on a sub-board of the IP camera. The system power provides operating voltage for the sub-power source.

However, when assembling different types of image sensors on the sub-board, the power circuits on the main board may need to be accordingly changed and relocated to provide suitable operating voltage for the relocated image sensors. The relocation and disassembly may increase design complexity and layout difficulty of the main board.

Therefore, there is room for improvement within the art.

### BRIEF DESCRIPTION OF THE DRAWINGS

Many aspects of an exemplary power conversion circuit and internet protocol camera employing the same can be better understood with reference to the following drawings. The components in the drawings are not necessarily drawn to scale, the emphasis instead being placed upon clearly illustrating the principles of the exemplary power conversion circuit and internet protocol camera employing the same. Moreover, in the drawings, like reference numerals designate corresponding parts throughout the several views. Wherever possible, the same reference numbers are used throughout the drawings to refer to the same or like elements of an embodiment.

FIG. 1 is a circuit view of an internet protocol camera including a power conversion circuit, according to an exemplary embodiment.

FIG. 2 is a circuit view of one embodiment of a power conversion circuit used in an internet protocol camera such as, for example, that of FIG. 1.

### DETAILED DESCRIPTION

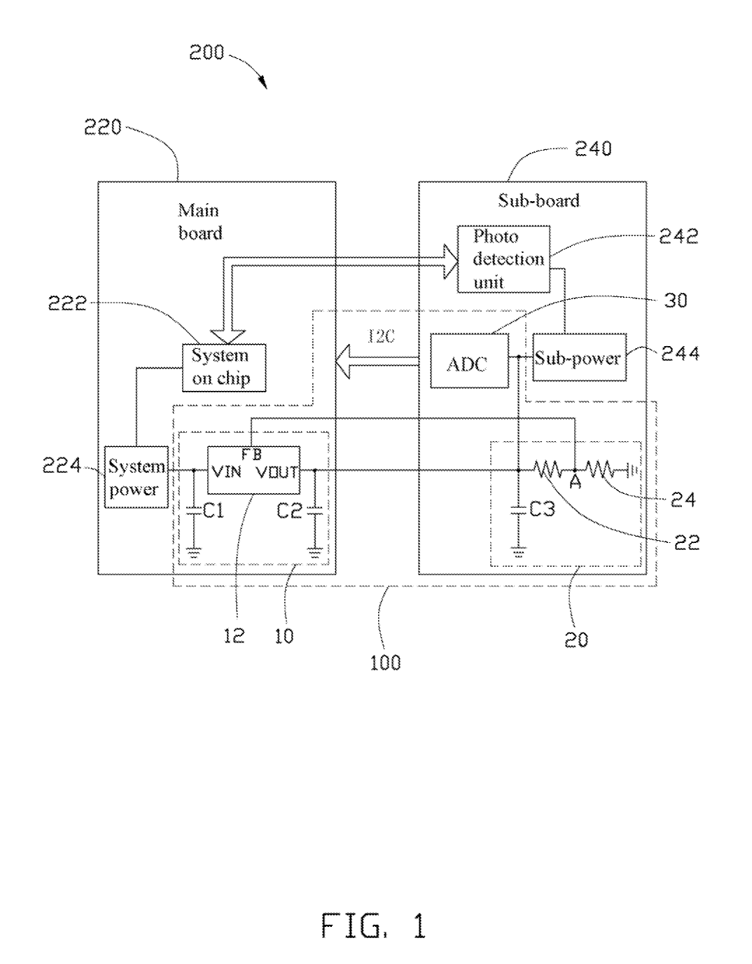

FIG. 1 shows an exemplary embodiment of a power conversion circuit 100 used in an internet protocol (IP) camera 200. The IP camera 200 includes a main board 220 and a sub-board 240 electrically connected to the main board 220 through, for example, an inter-integrate circuit (I2C) bus. The main board 220 includes a system on chip (SOC) 222, a system power 224, and other support electronic components (not shown), such as audio chips and image processing chips.

The SOC 222 is electrically located on the main board 220, and is capable of reading and processing application programs directing the IP camera 200 to output and provide video signals. The system power 224 is electrically located on the main board 220, and is electrically connected to the SOC 222. The system power 224 is capable of providing corresponding operating voltages for the electronic components on the main board 220 and the sub-board 240.

The sub-board 240 includes a photo detection unit 242 and a sub-power 244. The photo detection unit 242 can be a complementary metal oxide semiconductor (CMOS) sensor or a charge coupled device (CCD) sensor. The photo detection unit 242 is electrically connected to the SOC 222 and is operable for directly converting optical signals into corresponding digital signals to acquire, store, transmit, and process the video images.

The sub-power 224 is electrically connected to the photo detection unit 242, and provides operating voltage for the photo detection unit 242. The voltage of the sub-power 224 is accordingly changed with output voltage of the power conversion circuit 100.

The power conversion circuit 100 is electrically connected to the system power 224 and the sub-power 244, and is capable of receiving an output voltage from the system 224, and adjusting and converting the output voltage to provide a corresponding stable voltage for the sub-power 244. The power conversion circuit 100 includes a voltage conversion circuit 10, a divider circuit 20, and an analog to digital converter (ADC) 30.

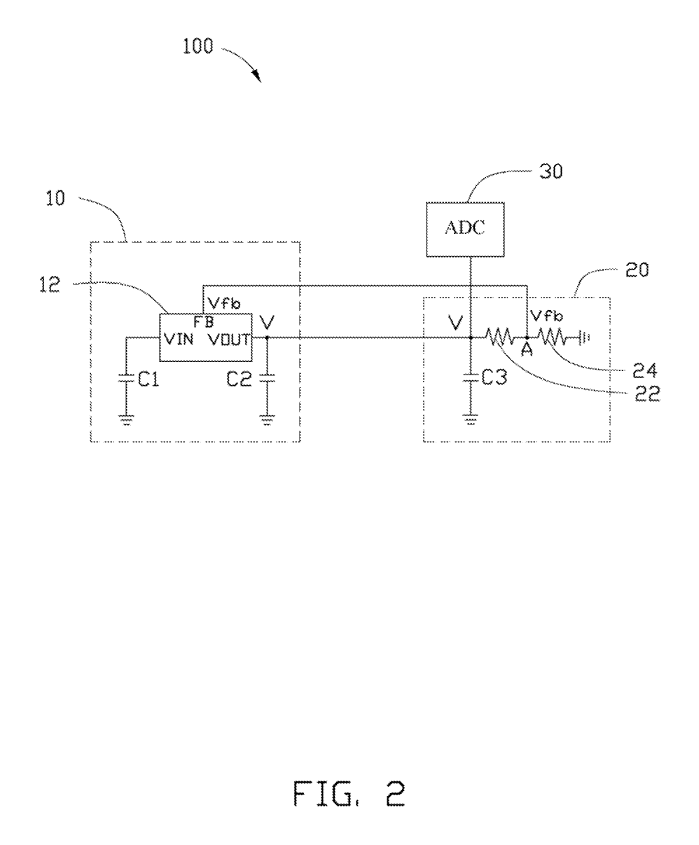

Also referring to FIG. 2, the voltage conversion circuit 10 is electrically located on the main board 220 and includes a linear voltage regulator 12, a first capacitor C1, and a second capacitor C2. In this exemplary embodiment, the linear voltage regulator 12 can be a low dropout regulator (LDO), having a predetermined reference voltage Vref. The linear voltage regulator 12 generates and outputs a regulated stable voltage by repeatedly comparing the Vref with a feedback voltage Vfb.

The linear voltage regulator 12 includes an input port VIN, an output port VOUT, and a feedback port FB. The input port VIN is electrically connected to the system power 224 to receive direct current (DC), and the DC is output to the output port VOUT after direct current to direct current (DC/DC) conversion. The feedback port FB is operable for receiving feedback voltage Vfb from the divider circuit 20.

The input port VIN is further electrically connected to ground through the first capacitor C1, and the output port VOUT is further electrically connected to the ground through the second capacitor C2. The first capacitor C1 and the second capacitor C2 are capable of filtering noise to stabilize the input voltage of the input port VIN and the output voltage of the output port VOUT.

The divider circuit 20 is electrically positioned on the sub-board 240 and provides the feedback voltage Vfb for the linear voltage regulator 12. The divider circuit 20 includes a first divider resistance 22, a second divider resistance 24, and a third capacitor C3. In this exemplary embodiment, an end of the first divider resistance 22 is electrically connected to the sub-power 244, the ADC 30, the third capacitor C3 and the output port VOUT of the linear voltage regulator 12. Another end of the first divider resistance 22 is electrically connected to an end of the second divider resistance 24. The other end of the second divider resistance 24 is electrically connected to ground. The feedback port FB of the linear voltage regulator 12 is electrically connected between the first divider resistance 22 and the second divider resistance 24, forming a node A. The third capacitor C3 can be a filter capacitor and is electrically connected to ground.

Further referring to FIG. 2, the ADC 30 is positioned on the sub-board 240 and is electrically connected to the sub-power 244 and the output port VOUT of the linear voltage regulator 12. The ADC 30 is further electrically connected to the SOC 222 through the I2C bus. The ADC 30 is capable of receiving and converting the voltage signals from the linear voltage regulator 12 into corresponding digital signals, and transmitting the digital signals to the SOC 222. Thus, the SOC 222 can obtain the operating voltage of the sub-board 240 and the photo detection unit 242 and control the photo detection unit 242 according to the digital signals.

In use, if the output voltage of the output port VOUT is set as V, the resistances of the first divider resistance 22 and the second divider resistance 24 are respectively set as R1 and R2. Accordingly, the feedback voltage Vfb of the feedback port FB is obtained by the following formula: Vfb=VR2/(R1+R2). The linear voltage regulator 12 compares the Vfb with the predetermined reference voltage Vref, and accordingly adjusts the output voltage V of the output port VOUT until the feedback voltage Vfb is substantially equal to the reference voltage Vref. The output voltage V of the output port VOUT then can be calculated by the following formula: V=Vfb*(1+R1/R2)=Vref*(1+R1/R2), where the Vref is a constant. Thus, the output voltage V can be obtained by correspondingly adjusting or changing the first divider resistance R1 and/or the second divider resistance R2, and is provided for the photo detection unit 242 as the operating voltage.

The first divider resistance 22 and the second divider resistance 24 can be slide rheostats, or passive components, such as capacitors and inductors.

Moreover, the sub-power 244 can be omitted, and the output port VOUT of the linear voltage regulator 12 directly and electrically connected to and providing operating voltage for the ADC 30 and the photo detection unit 242.

In summary, in the power conversion circuit 100 and the IP camera 200 as disclosed, the linear voltage regulator 12 outputs and provides operating voltages for the photo detection unit 242 by adjusting the first divider resistance 22 and/or the second divider resistance 24. Thus, there is no need to relocate the matchable circuits on the main board 220, optimizing ease of use, versatility, and universality of the main board 220.

It is to be understood, however, that even though numerous characteristics and advantages of the exemplary disclosure have been set forth in the foregoing description, together with details of the structure and function of the exemplary disclosure, the disclosure is illustrative only, and changes may be made in detail, especially in matters of shape, size, and arrangement of parts within the principles of exemplary disclosure to the full extent indicated by the broad general meaning of the terms in which the appended claims are expressed.

What is claimed is:

1. A power conversion circuit, comprising:
a voltage conversion circuit comprising a linear voltage regulator, the linear voltage regulator providing an operating voltage and comprising an input port, an output port, and a feedback port; and
a divider circuit electrically connected to the voltage conversion circuit, the divider circuit comprising a first divider resistance and a second divider resistance, wherein the output pot, the first divider resistance and the second divider resistance are electrically connected in series, the feedback port is electrically connected between the first divider resistance and the second divider resistance to obtain a feedback voltage, the input port is electrically connected to a system power, and the output port outputs and provides an output voltage adjusted by the feedback voltage.

2. The power conversion circuit as claimed in claim 1, further comprising an analog to digital converter electrically connected to the output port of the linear voltage regulator, wherein the analog to digital converter is capable of receiving and converting voltage signals from the linear voltage regulator into corresponding digital signals.

3. The power conversion circuit as claimed in claim 1, wherein the voltage conversion circuit further comprises a first capacitor and a second capacitor, and the input port of the linear voltage regulator is electrically connected to ground through the first capacitor, the output port of the linear voltage regulator is electrically connected to ground through the second capacitor.

4. The power conversion circuit as claimed in claim 3, wherein the first capacitor and the second capacitor are capable of filtering noise to stabilize the input voltage of the input port and the output voltage of the output port of the linear voltage regulator.

5. The power conversion circuit as claimed in claim 2, wherein the divider circuit further comprises a third capacitor, an end of the first divider resistance is electrically connected to the analog to digital converter, the third capacitor and the output port of the linear voltage regulator, another end of the third capacitor is electrically connected to ground.

6. The power conversion circuit as claimed in claim 1, wherein an end of the second divider resistance is electrically connected to ground to provide the feedback voltage for the feedback port of the linear voltage regulator.

7. The power conversion circuit as claimed in claim 1, wherein the first divider resistance and the second divider resistance are slide rheostats.

8. The power conversion circuit as claimed in claim 1, wherein the first divider resistance and the second divider resistance are capacitors or inductors.

9. The power conversion circuit as claimed in claim 1, wherein the linear voltage regulator is a low dropout regulator.

10. An internet protocol camera, comprising:
a system power providing an output power for the internet protocol camera;
a photo detection unit; and
a power conversion circuit electrically connected to the system power and the photo detection unit, the power conversion circuit comprising:
a voltage conversion circuit electrically connected to the system power and the photo detection unit, the voltage conversion circuit having a predetermined reference voltage; and
a divider circuit electrically connected to the voltage conversion circuit and the photo detection unit, wherein the divider circuit provides a feedback voltage to the voltage conversion circuit, the voltage conversion circuit compares the feedback voltage with the reference voltage to adjust the output voltage of the system power, and converts the output voltage into a corresponding operating voltage of the photo detection unit.

11. The internet protocol camera as claimed in claim 10, further comprising a main board and a sub-board, the system power and the voltage conversion circuit being located on the main board, and the divider circuit being located on the sub-board.

12. The internet protocol camera as claimed in claim 10, wherein the power conversion circuit further comprises an analog to digital convertor electrically connected to the divider circuit, the analog to digital converter receives and converts the operating voltage from the voltage conversion circuit into corresponding digital signal.

13. The internet protocol camera as claimed in claim 12, further comprising a system on chip, wherein the system on chip receives the digital signal from the voltage conversion circuit, and obtains the operating voltage of the photo detection unit.

14. The internet protocol camera as claimed in claim 12, wherein the divider circuit comprises a first divider resistance and a second divider resistance, and the voltage conversion circuit comprises a linear voltage regulator, the linear voltage regulator comprises an input port, an output port, and a feedback port, wherein the input port is electrically connected to the system power, the feedback port is electrically connected between the first divider resistance and the second divider resistance to obtain the feedback voltage, the input port is electrically connected to the first divider resistance.

15. The internet protocol camera as claimed in claim 14, wherein the voltage conversion circuit further comprises a first capacitor and a second capacitor, and the input port of the linear voltage regulator is electrically connected to ground through the first capacitor, the output port of the linear voltage regulator is electrically connected to ground through the second capacitor.

16. The internet protocol camera as claimed in claim 15, wherein the first capacitor and the second capacitor are capable of filtering noise to stabilize the input voltage of the input port and the output voltage of the output port of the linear voltage regulator.

17. The internet protocol camera as claimed in claim 15, wherein the divider circuit further comprises a third capacitor, an end of the first divider resistance is electrically connected to the analog to digital converter, the third capacitor and the output port of the linear voltage regulator, another end of the third capacitor is electrically connected to ground.

18. The internet protocol camera as claimed in claim 14, wherein an end of the second divider resistance is electrically connected to ground to provide the feedback voltage for the feedback port of the linear voltage regulator.

19. The internet protocol camera as claimed in claim 14, wherein the first divider resistance and the second divider resistance can be slide rheostats, capacitors or inductors.

20. The internet protocol camera as claimed in claim 10, wherein the linear voltage regulator is a low dropout regulator.
